(19) United States
(12) Patent Application Publication
(10) Pub. No.: US 2007/0277946 A1
(43) Pub. Date: Dec. 6, 2007

(54) Partitioning apparatus

(76) Inventor: Lizzeta G. Galvan, Kentwood, MI (US)

Correspondence Address: Lizzeta Galvan, 3314 South Creek Dr SE # 203, Kentwood, MI, 49512, US

(21) Appl. No.: 11/810,037

(22) Filed: Jun. 4, 2007

Related U.S. Application Data
(60) Provisional application No. 60/803,713, filed on Jun. 2, 2006.

(51) Int. Cl. E06B 9/00

(52) U.S. Cl. 160/368.1

(57) ABSTRACT

A partitioning apparatus. At least some of the illustrative embodiments are apparatuses comprising a base, and a panel coupled to the base. The apparatus is configured to partition a space.

### CROSS-REFERENCE TO RELATED APPLICATIONS

This application claims the benefit of Provisional Application Ser. No. 60/803,713 filed Jun. 2, 2006, entitled “Partitioning Apparatus”, which is incorporated by reference herein as if reproduced in full below.

### BACKGROUND

Partitioning space is an issue encountered by businesses and individuals alike whether setting up an office space, a design display, or a living space. Current methods of partitioning spaces such as when setting up an office cubicle space may use heavy walls or slats that may be complicated to assemble. Further, specialized tools or training may be called for in the assembly of such partitions. Also, the materials and methods used to manufacture such partitions may be complex and costly.

### SUMMARY

The problems noted above are solved in large part by a partitioning apparatus. At least some of the illustrative embodiments are apparatuses comprising a base, and a panel coupled to the base. The apparatus is configured to partition a space.

Other illustrative embodiments are apparatuses comprising a base comprising a first recess, a panel comprising a second recess, and an interlocking assembly. The interlocking assembly couples the second recess of the panel to the first recess of the base. The apparatus is configured to partition a space.

### BRIEF DESCRIPTION OF THE DRAWINGS

For a detailed description of the preferred embodiments of the invention, reference will now be made to the accompanying drawings in which:

FIG. 1 illustrates a partitioning apparatus in accordance with embodiments of the invention comprising a base and panels.

FIG. 2 illustrates a panel in accordance with embodiments of the invention.

FIG. 3 illustrates an alternative embodiment of a panel in accordance with embodiments of the invention.

FIG. 4 illustrates an isometric view of a partitioning apparatus in accordance with embodiments of the invention.

FIG. 5 illustrates an isometric view of a partitioning system in accordance with embodiments of the invention.

FIG. 6 illustrates a side view of a partitioning apparatus in accordance with embodiments of the invention.

FIG. 7 illustrates a side view of alternatively shaped embodiments of a base in accordance with embodiments of the invention.

FIG. 8 illustrates a front view of alternatively shaped embodiments of a panel in accordance with embodiments of the invention.

FIG. 9 illustrates alternatively shaped embodiments of a panel in accordance with embodiments of the invention.

FIG. 10 illustrates an isometric view of a convex partitioning apparatus in accordance with embodiments of the invention.

FIG. 11 illustrates a capping panel in accordance with embodiments of the invention.

FIG. 12 illustrates an alternative embodiment of a panel in accordance with embodiments of the invention.

### NOTATION AND NOMENCLATURE

Certain terms are used throughout the following description and claims to refer to particular system components. This document does not intend to distinguish between components that differ in name but not function.

In the following discussion and in the claims, the terms “comprises” and “comprising” are used in an open-ended fashion, and thus should be interpreted to mean “including, but not limited to . . . ”. Also, the term “couple” or “couples” is intended to mean either an indirect or a direct connection. Thus, if a first device coupled to a second device, that connection may be through a direct connection, or through an indirect connection via other devices and connections.

### DETAILED DESCRIPTION

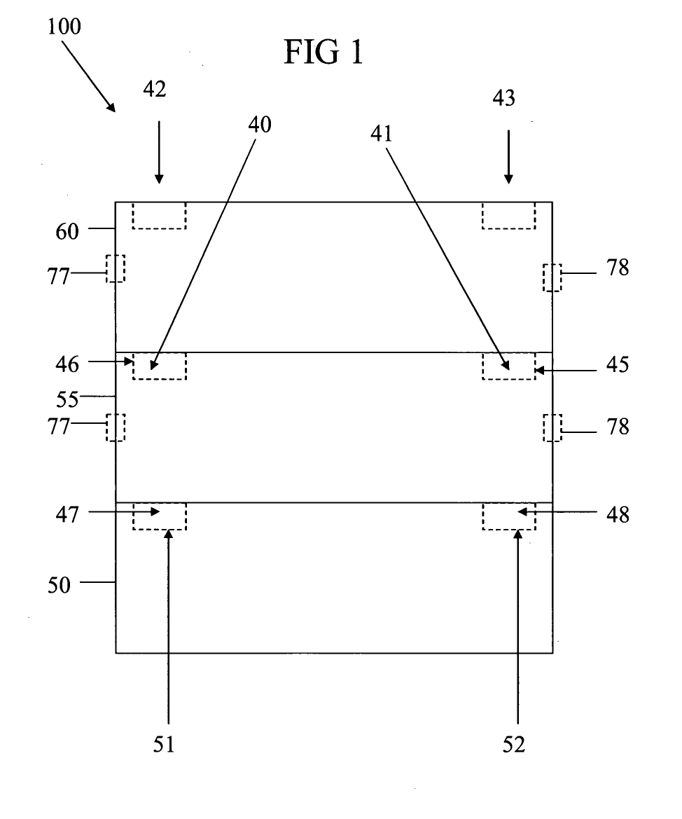

FIG. 1 illustrates a partitioning apparatus 100 comprising a first panel 60. The first panel 60 comprises a first projection 40, a second projection 41, a first recess 42, and a second recess 43. The apparatus 100 further comprises a second panel 55 comprising a first projection 47, a second projection 48, a first recess 46, and a second recess 45. The second panel 55 is operatively coupled to the first panel 60 by way of the recesses and projections. Specifically, the first projection 40 couples within the first recess 46 and the second projection 41 couples within the second recess 45. The apparatus 100 further comprises a base 50 comprising a first recess 51 and a second recess 52. The base 50 is operatively coupled to the second panel 55 by way of the recesses and projections. Specifically, the first projection 47 is coupled within the first recess 51 and the second projection 48 is coupled within the second recess 52. Moreover, the base 50 is configured to stabilize and support the weight of both the first and second panels 60 and 55, respectively. As shown in FIG. 1, the panels and the base 50 are substantially rectangular in shape. In alternative embodiments, the panels and the base 50 may be shaped as triangular, elliptical, round, square, trapezoidal, or an alternative polygon. Further, the base 50 and panels may comprise embellishments or decorative designs. Also, in alternative embodiments, a different number of panels may be coupled to the first or second panel or the base 50.

The first panel 60, the second panel 55, and the base 50 may be prefabricated modules manufactured from plastic. In alternative embodiments, the first panel 60, the second panel 55, and the base 50 may be manufactured from a material such as wood, polymer, metal, laminate, stone, or foam, among others. In yet other alternative embodiments, the panels and the base 50 may be manufactured from other, distinct materials.

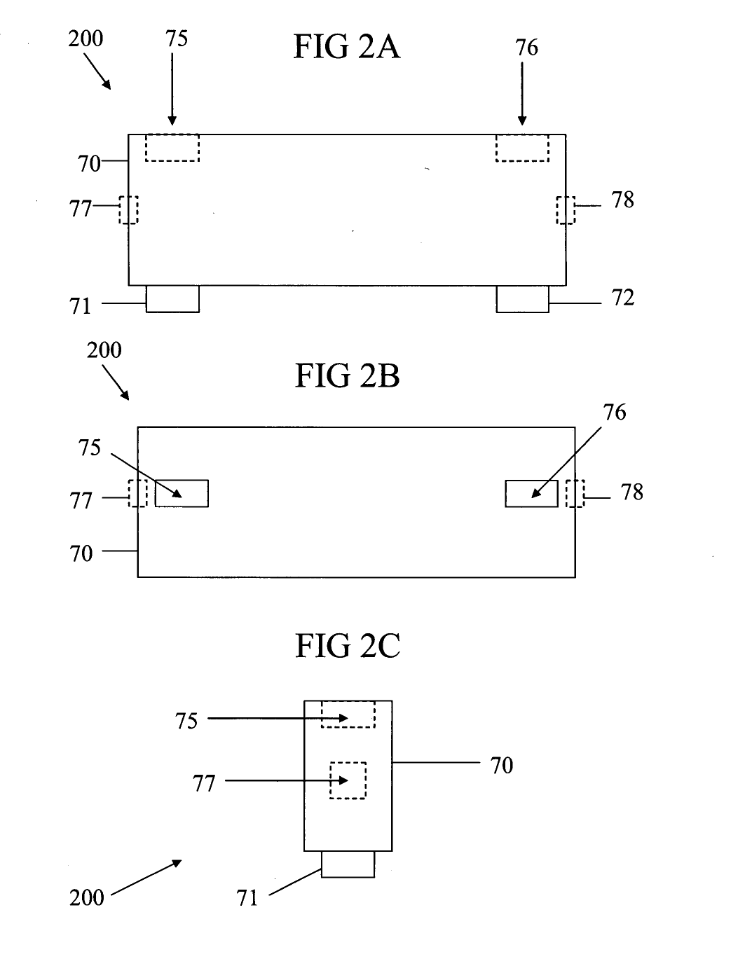

FIGS. 2A and 2B illustrate a front view and a top view, respectively, of an individual panel 70. The panel 70 comprises a first recess 75, a second recess 76, a first projection 71, and a second projection 72. Additionally, the panel 70 may optionally comprise (as indicated by the dashed lines) a first interlocking assembly 77 and a second interlocking assembly 78. The interlocking assemblies 77 and 78 may comprise a hook, a latch, a snap, or alternative coupling assembly. In alternative embodiments, a selected group of panels of the partitioning apparatus 100 (FIG. 1) may comprise the interlocking assemblies 77 and 78. In yet other alternative embodiments, all of the panels of the partitioning apparatus 100 (FIG. 1) may comprise the interlocking assemblies 77 and 78. In alternative embodiments, the base 50 (FIG. 1) may comprise the interlocking assemblies 77 and 78. FIG. 2C illustrates an end view of the panel 70 comprising the first recess 75, the first projection 71, and the interlocking assembly 77.

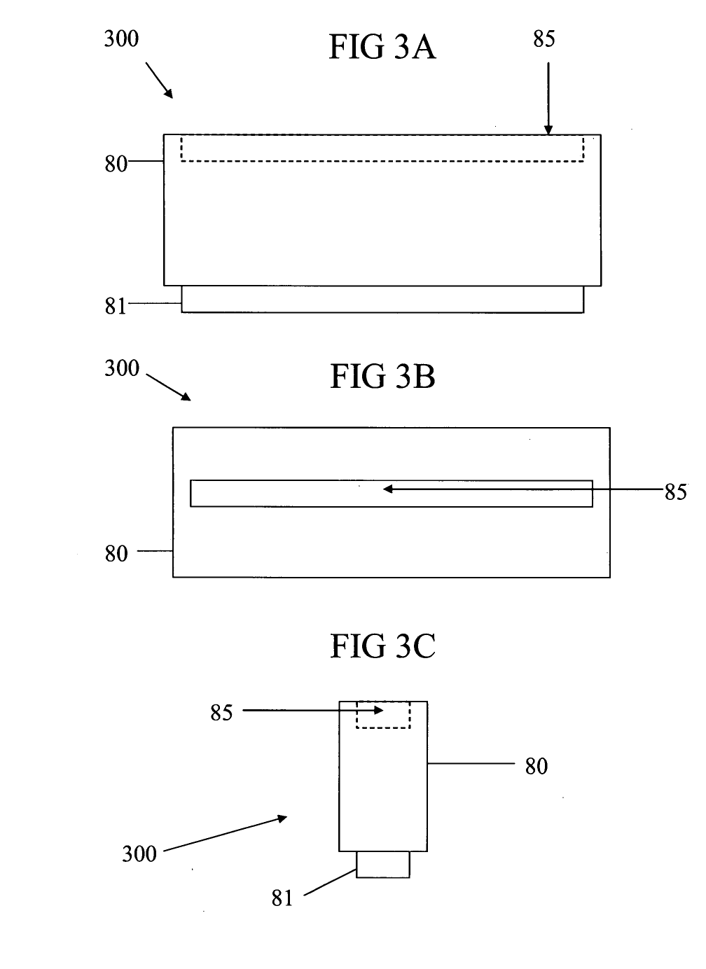

FIGS. 3A and 3B illustrate a front view and a top view, respectively, of an individual panel 80. The panel 80 comprises a first recess 85 and a first projection 81. FIG. 3C illustrates an end view of the panel 80 comprising the first recess 85 and the first projection 81. The panel 70 (FIG. 2) and the panel 80 comprise two (2) and one (1) recesses and projections, respectively. However, in alternative embodiments, the panels may comprise a distinct number of recesses and projections.

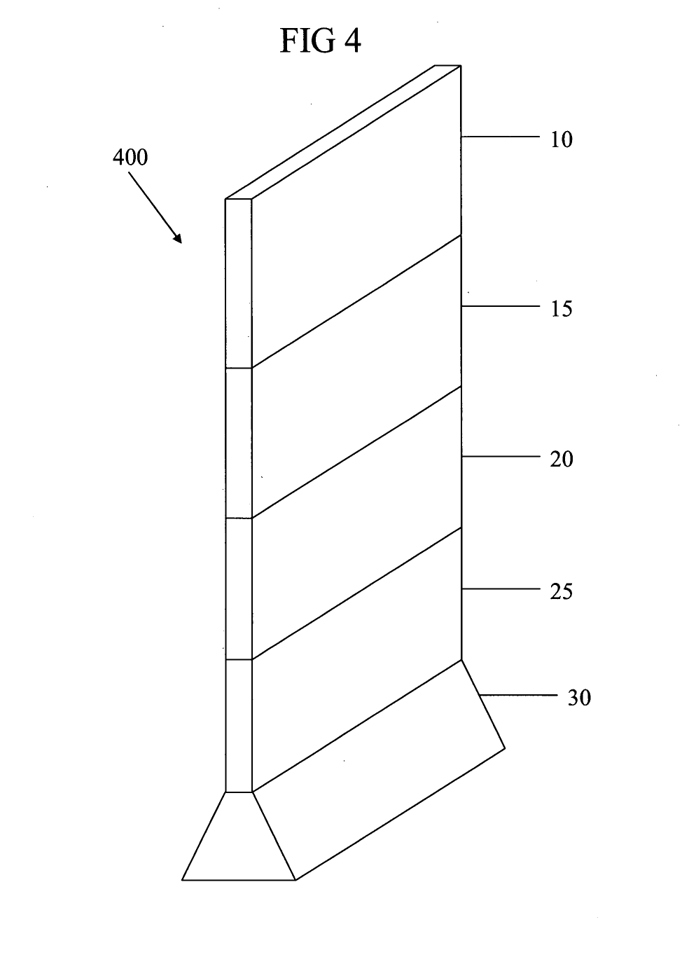

FIG. 4 shows an isometric view of a partitioning apparatus 400 comprising a first panel 10 operatively coupled to a second panel 15. The second panel 15 is operatively coupled to a third panel 20, and the third panel 20 is operatively coupled to a fourth panel 25. The fourth panel 25 is further operatively coupled to a base 30.

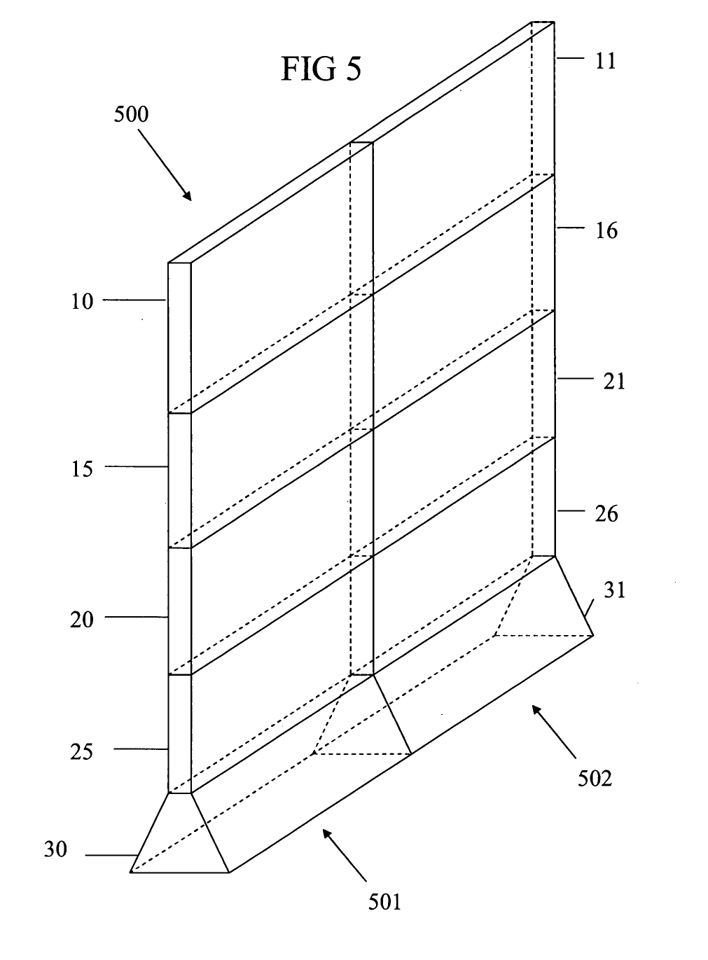

FIG. 5 illustrates an isometric view of a partitioning system 500 comprising a first partitioning apparatus 501 and a second partitioning apparatus 502 operatively coupled to the first partitioning apparatus 501 (e.g., by way of interlocking assemblies). The first partitioning apparatus 501 comprises the first panel 10 operatively coupled to the second panel 15. The second panel 15 is operatively coupled to the third panel 20, and the third panel 20 is operatively coupled to the fourth panel 25. The fourth panel 25 is further operatively coupled to the base 30. The second partitioning apparatus 502 comprises a first panel 11 operatively coupled to a second panel 16. The second panel 16 is operatively coupled to a third panel 21, and the third panel 21 is operatively coupled to a fourth panel 26. The fourth panel 26 is further operatively coupled to a base 31. In some exemplary embodiments, the partitioning system 500 may comprise a distinct number of partitioning apparatuses.

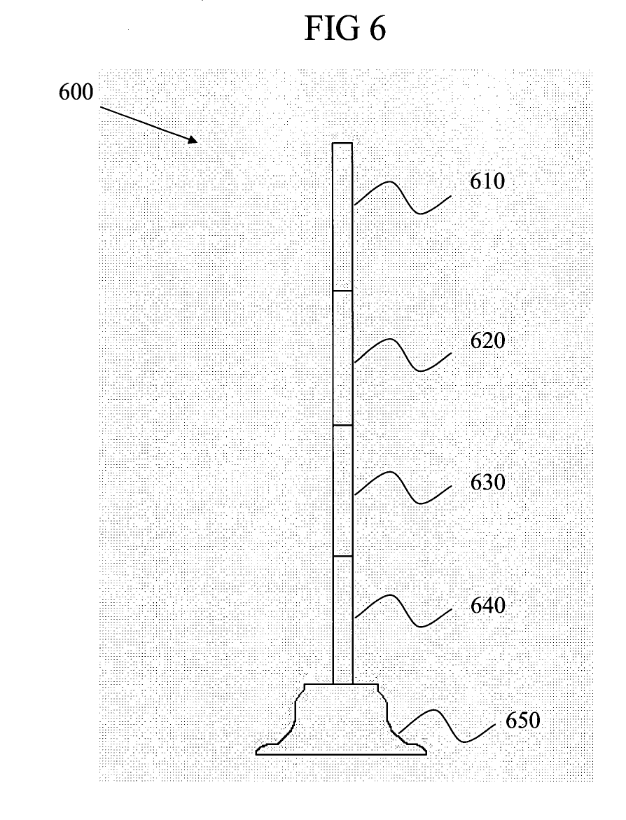

FIG. 6 illustrates a side view of a partitioning apparatus 600 in accordance with embodiments of the invention comprising a first panel 610 operatively coupled to a second panel 620. The second panel 620 is operatively coupled to a third panel 630, and the third panel 630 is operatively coupled to a fourth panel 640. The fourth panel 640 is further operatively coupled to a base 650.

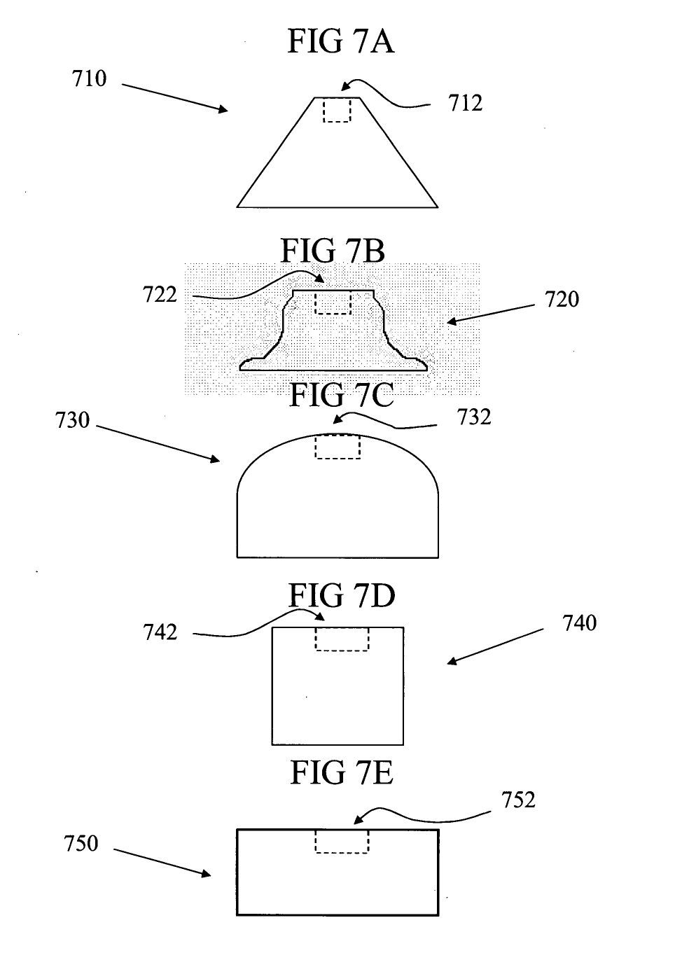

FIG. 7 illustrates a side view of alternatively shaped embodiments of a base of the partitioning apparatus 100 (FIG. 1) in accordance with embodiments of the invention. Specifically, FIG. 7A illustrates a side view of a base 710 that is substantially trapezoidal in shape comprising a recess 712. FIG. 7B illustrates a side view of a base 720 that is substantially irregular in shape comprising a recess 722. FIG. 7C shows a side view of a base 730 that is substantially rounded in shape comprising a recess 732. FIG. 7D illustrates a side view of a base 740 that is substantially square in shape comprising a recess 742. FIG. 7E shows a side view of a base 750 that is substantially rectangular in shape comprising a recess 752. In alternative embodiments, the base may comprise other distinct shapes. Additionally, the bases illustrated in FIGS. 7A-7E may comprise a distinct number of recesses.

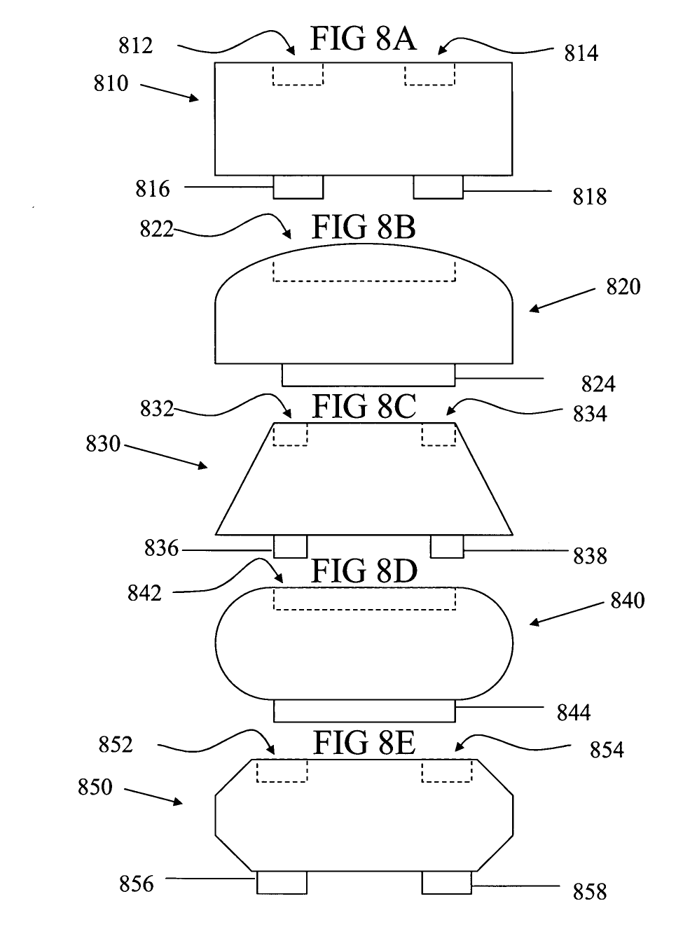

FIG. 8 illustrates a front view of alternatively shaped embodiments of a panel of the partitioning apparatus 100 (FIG. 1) in accordance with embodiments of the invention. Specifically FIG. 8A illustrates a front view of a panel 810 that is substantially rectangular in shape comprising a first recess 812, a second recess 814, a first projection 816, and a second projection 818. FIG. 8B illustrates a front view of a panel 820 that is substantially rounded in shape comprising a first recess 822 and a first projection 824. FIG. 8C shows a front view of a panel 830 that is substantially trapezoidal in shape comprising a first recess 832, a second recess 834, a first projection 836, and a second projection 838. FIG. 8D illustrates a front view of a panel 840 that is substantially oval in shape comprising a first recess 842 and a first projection 844. FIG. 8E shows a front view of a panel 850 that is substantially hexagonal in shape comprising a first recess 852, a second recess 854, a first projection 856, and a second projection 858. In alternative embodiments, the panels illustrated in FIGS. 8A-8E may comprise other distinct shapes. In yet other alternative embodiments, the panels may comprise a distinct number of recesses and projections.

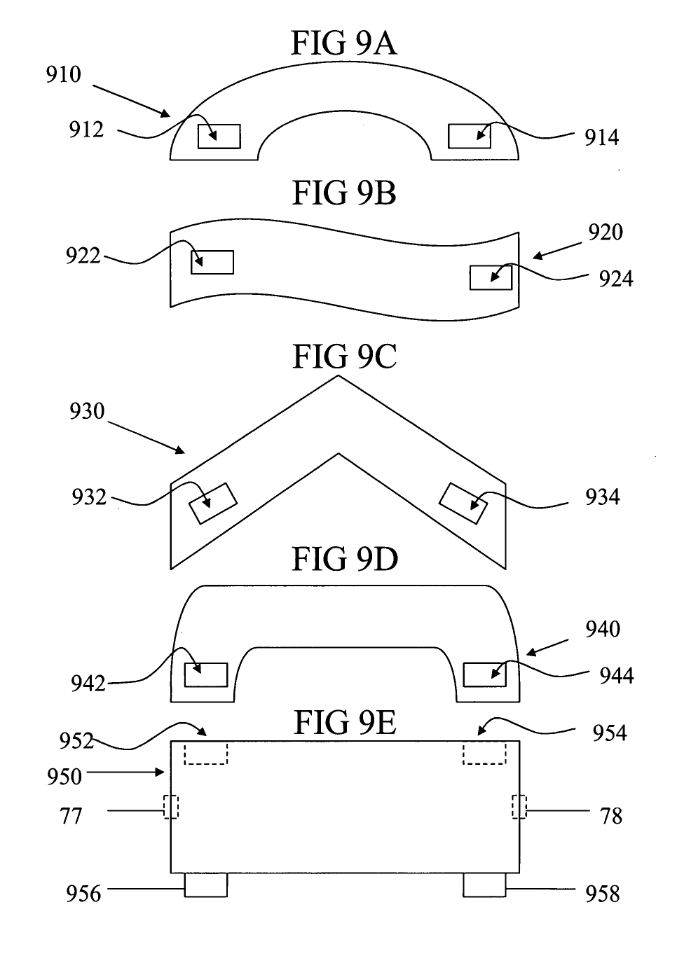

FIG. 9 illustrates alternatively shaped embodiments of a panel. Specifically, FIG. 9A shows a top view of a panel 910 that is substantially convex in shape comprising a first recess 912 and a second recess 914. FIG. 9B illustrates a top view of a panel 920 that is substantially S-shaped comprising a first recess 922 and a second recess 924. FIG. 9C shows a top view of a panel 930 that is substantially triangular in shape comprising a first recess 932 and a second recess 934. FIG. 9D illustrates a top view of a panel 940 that is substantially trapezoidal in shape comprising a first recess 942 and a second recess 944. It will be understood that the alternatively shaped panels as illustrated in FIG. 9A-9D may also correspond to alternatively shaped bases. Regardless of the shape as illustrated by the top views of FIGS. 9A-9D, the front view of the panels may remain substantially rectangular in shape as illustrated by the front view of a panel 950 of FIG. 9E, wherein the panel 950 comprises a first recess 952, a second recess 954, a first projection 956, a second projection 958, and optionally comprises (as indicated by the dashed lines) the first interlocking assembly 77 and the second interlocking assembly 78. Additionally, in alternative embodiments, the panels as illustrated in FIGS. 9A-9E may comprise a distinct number of recesses and projections. In yet other embodiments, the front view of the panel 950 may be shaped as triangular, elliptical, round, square, trapezoidal, or an alternative polygon.

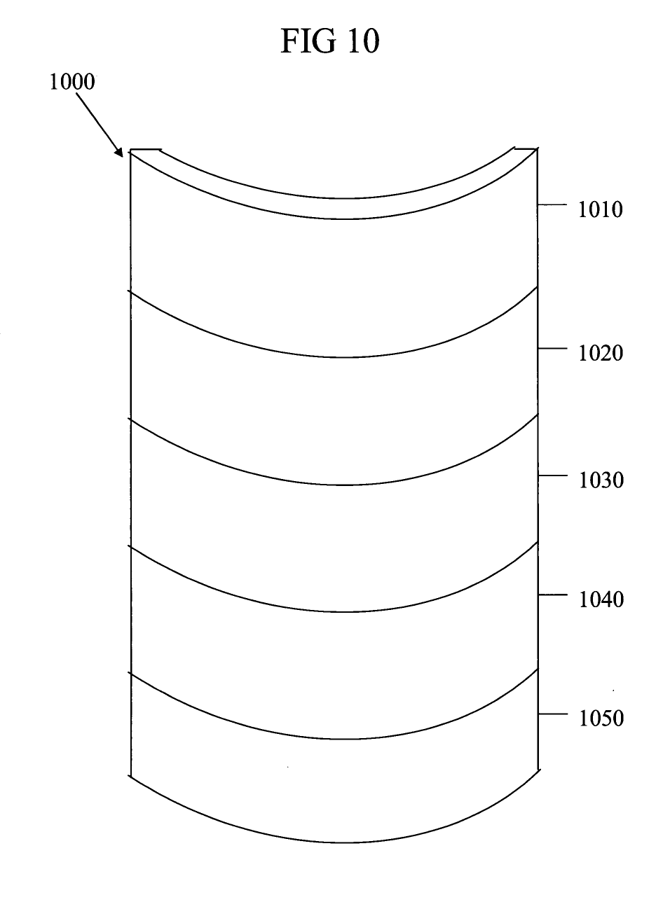

FIG. 10 shows an isometric view of a convex partitioning apparatus 1000 comprising a first panel 1010 operatively coupled to a second panel 1020. The second panel 1020 is operatively coupled to a third panel 1030, and the third panel 1030 is operatively coupled to a fourth panel 1040. The fourth panel 1040 is further operatively coupled to a base 1050.

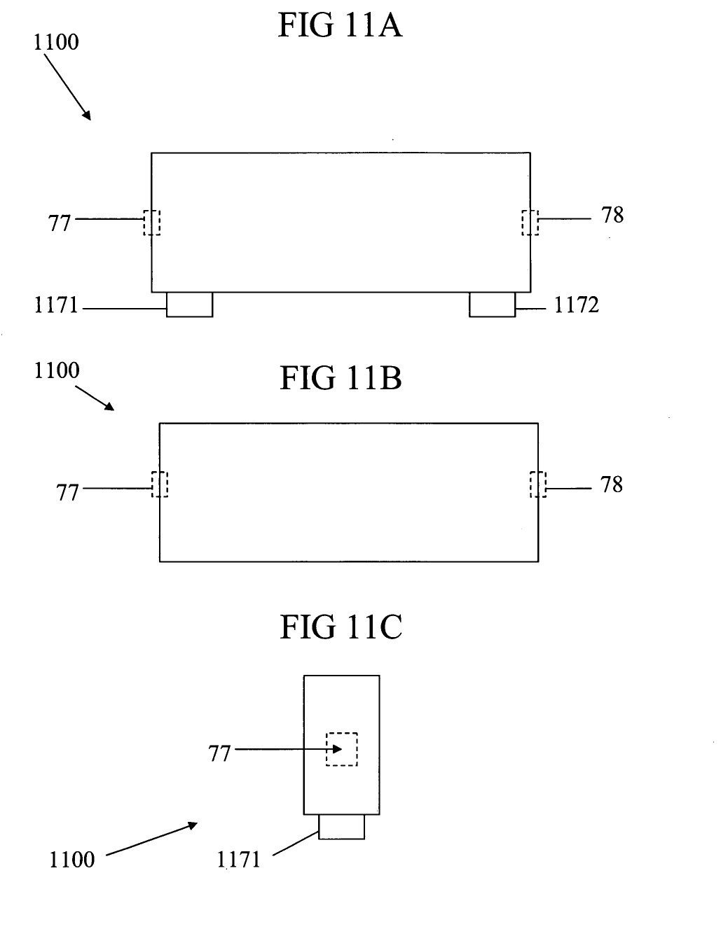

FIGS. 1A and 1B illustrate a front view and a top view, respectively, of a capping panel 1100 in accordance with embodiments of the invention. The capping panel 1100 comprises a first projection 1171 and a second projection 1172. Additionally, the capping panel 1100 may optionally comprise (as indicated by the dashed lines) the first interlocking assembly 77 and the second interlocking assembly 78. FIG. 11C illustrates an end view of the capping panel 1100 comprising the first projection 1171 and the interlocking assembly 77. As the capping panel 1100 does not comprise recesses, it may be used as the topmost panel of the partitioning apparatus 100.

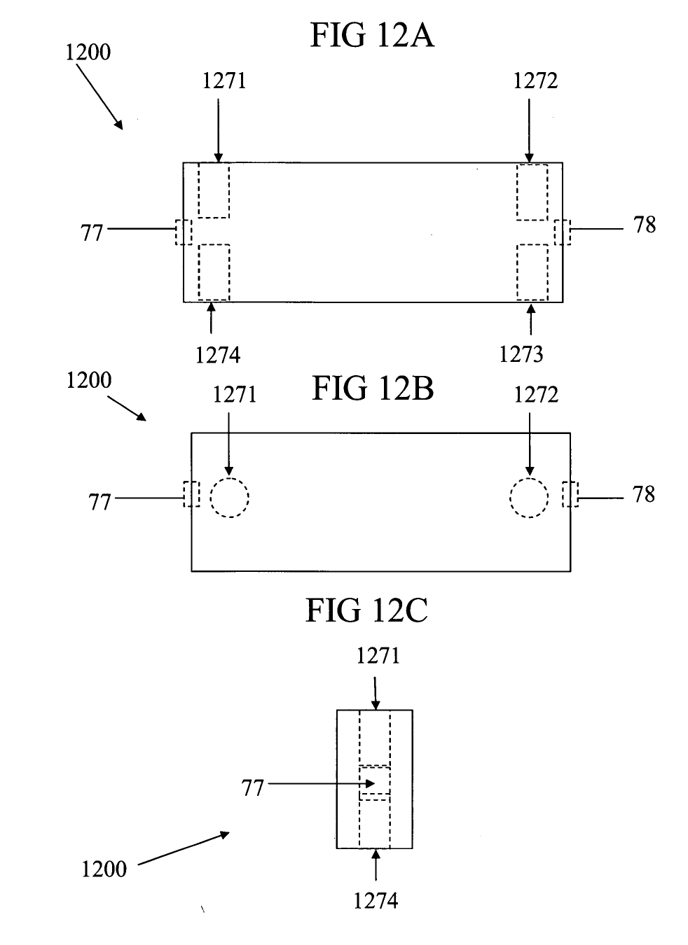

FIGS. 12A and 12B illustrate a front view and a top view, respectively, of an individual panel 1200. The panel 1200 comprises a first recess 1271, a second recess 1272, a third recess 1273, a fourth recess 1274, wherein the panel 1200 may be operatively coupled to a second panel by the use of a coupling assembly which may comprise a dowel, a hook, a latch, a snap, or alternative coupling assembly. For example, in some embodiments, a first end of a dowel is inserted into each of the recesses 1273, 1274, and a second end of a dowel is inserted into each of the corresponding recesses of the second panel, thereby operatively coupling the panel 1200 to the second panel. Additionally, the panel 1200 may optionally comprise (as indicated by the dashed lines) a first interlocking assembly 77 and a second interlocking assembly 78. The interlocking assemblies 77 and 78 may comprise a hook, a latch, a snap, or alternative coupling assembly. FIG. 12C illustrates an end view of the panel 1200 comprising the first recess 1271, the second recess 1274, and the interlocking assembly 77.

The above description is meant to be illustrative of the principles and various embodiments of the present invention. Numerous variations and modifications will be apparent to those skilled in the art once the above disclosure is fully appreciated. It is intended that the following claims be interpreted to embrace all such variations and modifications.

What is claimed is:

1. An apparatus comprising:
a base; and
a panel coupled to the base;
wherein the apparatus is configured to partition a space.

2. An apparatus comprising:
a base comprising a first recess;
a panel comprising a second recess; and
an interlocking assembly;
wherein the interlocking assembly couples the first recess of the base to the second recess of the panel; and
wherein the apparatus is configured to partition a space.
